(19) United States
(12) Patent Application Publication
(10) Pub. No.: US 2009/0152236 A1
(43) Pub. Date: Jun. 18, 2009

(54) METHOD FOR MANUFACTURING LIQUID EJECTING HEAD AND LIQUID EJECTING APPARATUS

(75) Inventor: Hiroki Ikeda, Shiojiri-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/330,411

(22) Filed: Dec. 8, 2008

(30) Foreign Application Priority Data
Dec. 10, 2007 (JP) 2007-317988
Dec. 2, 2008 (JP) 2008-307104

(51) Int. Cl. B44C 1/22; B41J 2/16

(52) U.S. Cl. 216/27; 347/47

(57) ABSTRACT

A method for manufacturing a liquid ejecting head includes performing a dry cleaning process of cleaning the surface of a wire side of a second substrate by dry etching of a plasma etching mode, and performing a liquid cleaning process of cleaning the surface of a pressure generation chamber side of a first substrate.

### CROSS REFERENCES TO RELATED APPLICATIONS

The present invention contains subject matter related to Japanese Patent Application No. 2007-317988 filed in the Japanese Patent Office on Dec. 10, 2007 and Japanese Patent Application No. 2008-307104 filed in the Japanese Patent Office on Dec. 2, 2008, the entire contents of which are incorporated herein by reference.

### BACKGROUND OF THE INVENTION

1. Field of the Invention

The present invention relates to a method for manufacturing a liquid ejecting head and a liquid ejecting apparatus including the liquid ejecting head manufactured by the manufacturing method.

2. Description of Related Art

As an ink jet recording head which is a liquid ejecting head, for example, a liquid ejecting head including a channel forming substrate, in which pressure generation chambers communicating with nozzle openings are formed, a piezoelectric element formed on one surface of this channel forming substrate, and a reservoir forming substrate bonded to the surface of the channel forming substrate, on which the piezoelectric element is formed, and provided with a reservoir portion configuring a portion of a common ink chamber of the pressure generation chambers is disclosed in Japanese Unexamined Patent Application Publication No. 2006-272913.

In a method for manufacturing such an ink jet recording head, the piezoelectric element is formed on one surface of the channel forming substrate, the reservoir forming substrate is bonded to the channel forming substrate, and the pressure generation chambers are then formed by anisotropically etching the other surface of the channel forming substrate. In addition, a nozzle plate in which the nozzle openings are provided is bonded to the surface of the channel forming substrate, in which the pressure generating chambers are opened, via an adhesive.

In the above-described document, when the channel forming substrate is anisotropically etched, in order to prevent an etchant from being attached to the surface of the reservoir forming substrate on which wires are provided, a configuration in which a protective film is bonded to the surface of the reservoir forming substrate on which the wires are provided is disclosed. However, even when the protective film bonded to the reservoir forming substrate is stripped, a portion of the adhesive for adhering the protective film remains and the remaining adhesive becomes a foreign matter. When other wires such as bonding wires are connected to the wires, a connection failure occurs due to the foreign matter.

In addition, when the foreign matter is present in the liquid channels such as the pressure generation chambers of the channel forming substrate, the clogging of the nozzles occurs. In addition, as the foreign matter in the liquid channels of the channel forming substrate, the adhesive on the reservoir forming substrate or the like is mainly attached and becomes the foreign matter.

In addition, when an adhesion surface of the channel forming substrate is subjected to a hydrophilic treatment such as a primer treatment before the nozzle plate is bonded to the channel forming substrate, if a foreign matter is present in the liquid channels such as the pressure generation chambers of the channel forming substrate, this foreign matter is bonded to barrier walls of the liquid channels by the hydrophilic treatment, the foreign matter is stripped at an unexpected timing such as the ejection of an ink, and the clogging of the nozzles occurs. The ink jet recording apparatus including the ink jet recording head having such a problem still has the problem of the head. In addition, such a problem occurs in a method for manufacturing a liquid ejecting head for ejecting a liquid excluding an ink and a liquid ejecting apparatus including the head manufactured by the manufacturing method as well as the method for manufacturing the ink jet recording head.

### SUMMARY OF THE INVENTION

The invention is contrived to solve the above-described problems and can be realized as the following aspect or application example.

According to an aspect of the invention, there is provided a method for manufacturing a liquid ejecting head including at least a first substrate in which pressure generation chambers communicating with nozzle openings are provided, pressure generation units provided at one surface side of the first substrate so as to cause a pressure variation in the pressure generation chambers, and a second substrate bonded to the surface of the first substrate, in which the pressure generation units are provided, and having a wire formed on the surface thereof, the method including: performing a dry cleaning process of cleaning the surface of the wire side of the second substrate by dry etching of a plasma etching mode; and performing a liquid cleaning process of cleaning the surface of the pressure generation chamber side of the first substrate.

Features and advantages of the invention other than the above will become clear by reading the specification with reference to the accompanying drawings.

### BRIEF DESCRIPTION OF THE DRAWINGS

For complete understanding of the invention and the advantages thereof, reference is made to the following description taken in conjunction with the accompanying drawings.

FIG. 1 is an exploded perspective view showing the schematic configuration of a recording head according to Embodiment 1 of the invention.

FIG. 2 is a plan view and a cross-sectional view of the recording head according to Embodiment 1 of the invention.

FIG. 3 is a cross-sectional view showing a method for manufacturing the recording head according to Embodiment 1 of the invention.

FIG. 4 is a cross-sectional view showing the method for manufacturing the recording head according to Embodiment 1 of the invention.

FIG. 5 is a cross-sectional view showing the method for manufacturing the recording head according to Embodiment 1 of the invention.

FIG. 6 is a cross-sectional view showing the method for manufacturing the recording head according to Embodiment 1 of the invention.

FIG. 7 is a cross-sectional view showing the method for manufacturing the recording head according to Embodiment 1 of the invention.

FIG. 8 is a schematic view of a recoding apparatus of an embodiment of the invention.

### DETAILED DESCRIPTION OF PREFERRED ASPECTS

At least the following will become apparent according to the specification and the accompanying drawings.

According to an aspect of the invention, there is provided a method for manufacturing a liquid ejecting head including at least a first substrate in which pressure generation chambers communicating with nozzle openings are provided, pressure generation units provided at one surface side of the first substrate so as to cause a pressure variation in the pressure generation chambers, and a second substrate bonded to the surface of the first substrate, in which the pressure generation units are provided, and having a wire formed on the surface thereof, the method including: performing a dry cleaning process of cleaning the surface of the wire side of the second substrate by dry etching of a plasma etching mode; and performing a liquid cleaning process of cleaning the surface of the pressure generation chamber side of the first substrate.

In such an aspect, it is possible to remove a foreign matter such as an adhesive attached to the wire in the dry cleaning process, to prevent a connection failure of another wire, to remove a foreign matter in liquid channels such as the pressure generation chambers or the like in the liquid cleaning process, and to reduce the clogging of the nozzle openings.

As another aspect of the method for manufacturing the liquid ejecting head, the dry cleaning process may be performed after the liquid cleaning process is performed. Accordingly, even when the foreign matter scattered by the dry cleaning process is reattached to the liquid channels such as the pressure generation chambers or the like, it is possible to remove the reattached foreign matter and to reduce a foreign matter generation ratio.

As another aspect of the method for manufacturing the liquid ejecting head, the method may further include adhering a nozzle plate, in which the nozzle openings are provided, to an opened surface side of the first substrate, in which the pressure generation chambers are opened, after the cleaning process is performed.

Accordingly, it is possible to remove a foreign matter larger than the nozzle openings by removing the foreign matter before the nozzle plate is bonded.

As another aspect of the method for manufacturing the liquid ejecting head, after the cleaning process is performed, at least an area of the first substrate, which is bonded to the nozzle plate, is subjected to a hydrophilic treatment, and the nozzle plate is then is bonded to the second forming substrate via an adhesive.

Accordingly, it is possible to improve adhesion strength between the first substrate and the nozzle plate, to prevent the foreign matter in the liquid channels from being fixed by the hydrophilic treatment, and to prevent the nozzle openings from being clogged at an unexpected timing due to the stripping of the foreign matter.

As another aspect of the method for manufacturing the liquid ejecting head, the method may further include forming a protective film having liquid resistance on the inner surfaces of the pressure generation chambers of the first substrate, before the cleaning process is performed.

Accordingly, it is possible to protect the first substrate from the liquid by the protective film and to remove the foreign matter of the first substrate without changing the thickness of the protective film by the liquid cleaning process.

In addition, the “liquid resistance” described herein indicates a property for preventing the inner surfaces of the pressure generation chambers from deteriorating by the liquid flowing in the pressure generation chambers and suppressing deterioration by the above-described liquid compared with the material of the first substrate configuring the inner surfaces of the pressure generation chambers.

In addition, there is provided a liquid ejecting apparatus including the liquid ejecting head manufactured by the above-described method for manufacturing the liquid ejecting head.

Accordingly, it is possible to provide the liquid ejecting apparatus with more improved reliability than the related art.

Hereinafter, the exemplary embodiments of the invention will be described with reference to the accompanying drawings. In addition, the following embodiments are described as examples of the invention, and all the components described herein are not necessary components of the invention.

### BEST EMBODIMENTS

Hereinafter, the embodiments will be described with reference to the drawings.

### Embodiment 1

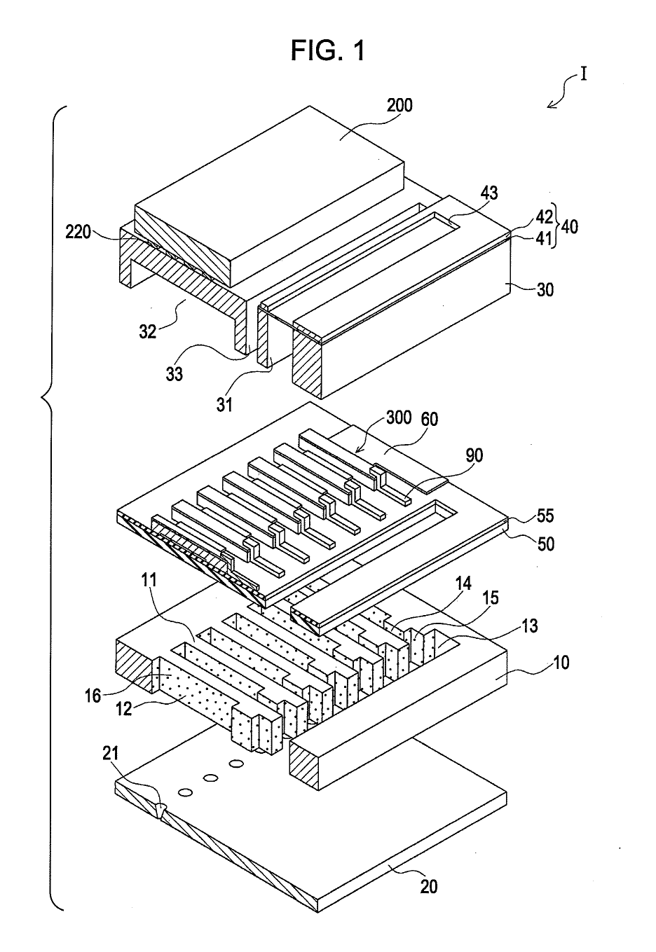

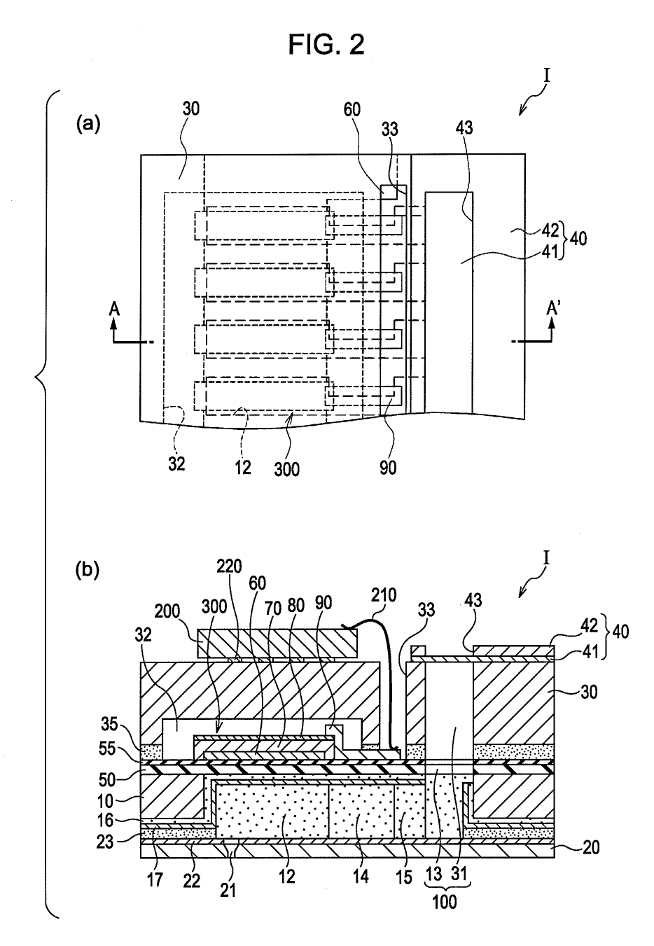

FIG. 1 is an exploded perspective view showing the schematic configuration of an ink jet recording head which is an example of a liquid ejecting head according to Embodiment 1 of the invention, and FIG. 2 is a plan view of FIG. 1 and a cross-sectional view taken along line A-A′. As shown, in the present embodiment, a channel forming substrate 10 is formed of a silicon single crystal substrate having a plane orientation (110), and an elastic film 50, which is formed of silicon oxide (SiO₂) and is formed by thermal oxidation in advance, is formed on one surface of the substrate.

In the channel forming substrate 10, a plurality of pressure generation chambers 12 is arranged in parallel along a width direction. In addition, a communicating portion 13 is formed in a longitudinal-direction outer area of the pressure generation chambers 12 of the channel forming substrate 10, and the communicating portion 13 and the pressure generation chambers 12 communicate with each other via ink supply paths 14 and communicating paths 15 respectively provided in the pressure generation chambers 12. The communicating portion 13 communicates with a reservoir portion 31 of a below-described protective substrate and configures a portion of a reservoir which becomes a common ink chamber of the pressure generation chambers 12. Each of the ink supply paths 14 is formed so as to have a width smaller than that of each of the pressure generation chambers 12 and constantly maintains channel resistance of an ink introduced from the communicating portion 13 to each of the pressure generation chambers 12. For example, although, in the present embodiment, the ink supply paths 14 are formed by narrowing the width of the channels at one side, the ink supply paths may be formed by narrowing the width of the channels at both sides. Instead of narrowing the width of the channels, the ink supply paths may be formed by narrowing the channels in the width direction. In addition, each of the communicating paths 15 is formed by extending the barrier walls 11 of both sides of the pressure generation chambers 12 in the width direction to the side of the communicating portion 13 and partitioning spaces between the ink supply paths 14 and the communicating portion 13. That is, the channel forming substrate 10 is partitioned by the plurality of barrier walls 11 including the ink supply paths 14 having a cross-sectional area smaller than that of the pressure generation chambers 12 in the width direction, and the communicating paths 15 communicating with the ink supply paths 14 and having a cross-sectional area larger than that of the ink supply paths 14 in the width direction.

In addition, in the channel forming substrate 10, liquid channels including the pressure generation chambers 12, the communicating portion 13, the ink supply paths 14 and the communicating paths 15 are formed.

On the inner surfaces of the liquid channels of such a channel forming substrate 10, a protective film 16 formed of a material having ink resistance, for example, tantalum oxide such as tantalum pentaoxide (Ta₂O₅) is provided. In addition, the “ink resistance” described herein is etching resistance for an alkali ink. In addition, the material of the protective 16 is not limited to tantalum oxide and, for example, zirconium oxide (ZrO₂), nickel (Ni), chrome (Cr) or the like may be used by the pH value of the used ink (liquid). However, if an acidic liquid is used, a protective film having acid resistance is used.

A nozzle plate 20, in which nozzle openings 21 communicating with the vicinity of the end of the opposite side of the ink supply paths 14 of the pressure generation chambers 12 are formed, is bonded to the opened surface side of the channel forming substrate 10 by an adhesive, a hot welding film or the like. In addition, in the present embodiment, although will be described in detail later, a first hydrophilic treatment layer 17 is provided on the surface of the channel forming substrate 10, to which the nozzle plate 20 is bonded, by performing a hydrophilic treatment, a second hydrophilic treatment layer 22 is provided on the surface of the nozzle plate 20 bonded to the channel forming substrate 10 by performing a hydrophilic treatment, and the first hydrophilic treatment layer 17 and the second hydrophilic treatment 22 are bonded to each other via an adhesive 23.

As the material of the nozzle plate 20, for example, glass ceramics, a silicon single crystal substrate, stainless steel, or the like may be used.

The elastic film 50 is formed on the opposite side of the opened surface of the channel forming substrate 10 as described above, and, for example, an insulating film 55 formed of zirconium oxide (ZrO₂) is formed on the elastic film 50. In addition, a lower electrode film 60, a piezoelectric layer 70 and an upper electrode film 80 are laminated on the insulating film 55 by a below-described process so as to configure piezoelectric elements 300. The piezoelectric elements 300 indicate the portion including the lower electrode film 60, the piezoelectric layer 70 and the upper electrode film 80. Generally, any one of the electrodes of the piezoelectric elements 300 is used as a common electrode, and the other electrode and the piezoelectric layer 70 are patterned in the pressure generation chambers 12. For example, in the present embodiment, the lower electrode film 60 is used as the common electrode of each of the piezoelectric elements 300 and the upper electrode film 80 is used as an individual electrode of each of the piezoelectric elements 300.

However, an opposite configuration may be used according to the state of a driving circuit or a wire. In the above-described example, the elastic film 50, the insulating film 55, and the lower electrode film 60 function as the vibration plates, but is not limited to this. For example, the elastic film 50 and the insulating film 55 may not be provided, and only the lower electrode film 60 may function as the vibration plates. Alternatively, the piezoelectric elements 300 may substantially function as the vibration plates.

The piezoelectric layer 70 is formed of a piezoelectric material having an electromechanical transduction property, which is formed on the lower electrode film 60. In the piezoelectric layer 70, a crystal film of a perovskite structure is preferably used, and, for example, a ferroelectric material such as lead zirconium titanate (PZT) or the like, a material, which is obtained by adding metal oxide such as niobium oxide, nickel oxide, magnesium oxide or the like thereto, or the like is suitably used. In detail, Lead titanate (PbTiO₃), lead zirconate titanate (Pb(Zr, Ti)O₃), lead zirconate (PbZrO₃), lead lanthanate titanate ((Pb, La), TiO₃) lead lanthanum zirconate titanate ((Pb, La) (Zr, Ti) O₃), lead magnesium niobate zirconate titanate (Pb(Zr, Ti) (Mg, Nb)O₃) or the like may be used. The thickness of the piezoelectric layer 70 is suppressed such that crack does not occur in the manufacturing process, and the piezoelectric layer is thickly formed such that sufficient displacement characteristics are obtained. For example, in the present embodiment, the piezoelectric layer 70 was formed with a thickness about 1 to 2 μm.

A lead electrode 90 which is led from the vicinity of the end of the side of the ink supply paths 14, is extended to the insulating film 55 and is formed of, for example, gold (Au) or the like is connected to the upper electrode film 80 which is the individual electrode of each of the piezoelectric elements 300.

A protective substrate 30 having the reservoir portion 31 configuring at least a portion of the reservoir 100 is bonded on the channel forming substrate 10 in which the piezoelectric elements 300 are formed, that is, on the lower electrode film 60, the elastic film 50 and the lead electrode 90, via an adhesive 35. In the present embodiment, the reservoir portion 31 penetrates through the protective substrate 30 in the width direction so as to be formed over the width direction of the pressure generation chambers 12, and communicates with the communicating portion 13 of the channel forming substrate 10 as described above so as to configure the reservoir 100 which becomes the common ink chamber of the pressure generation chambers 12. Alternatively, the communicating portion 13 of the channel forming substrate 10 may be divided into a plurality of portions in each of the pressure generation chambers 12 and only the reservoir portion 31 may function as the reservoir. Alternatively, for example, only the pressure generation chambers 12 may be provided in the channel forming substrate 10, and the ink supply paths 14 communicating with the reservoir and the pressure generation chambers 12 may be provided in a member (for example, the elastic film 50, the insulating film 55 or the like) interposed between the channel forming substrate 10 and the protective substrate 30.

In addition, a piezoelectric element holding portion 32 having a space which does not hinder the motion of the piezoelectric elements 300 is provided in an area opposing the piezoelectric elements 300 of the protective substrate 30. The piezoelectric element holding portion 32 may be sealed or may not be sealed if it has the space which does not hinder the motion of the piezoelectric elements 300.

As such a protective substrate 30, a material having the same thermal expansion as the channel forming substrate 10, for example, a glass or ceramic material or the like may be preferably used. In the present embodiment, a silicon single crystal substrate which is the same material as the channel forming substrate 10 was used.

A through-hole 33 penetrating through the protective substrate 30 in the width direction is provided in the protective substrate 30. The vicinity of the end of the lead electrode 90 led from the piezoelectric elements 300 is provided to be exposed in the through-hole 33.

A connection wire 220 formed in a predetermined pattern is formed on the protective substrate 30 and a driving circuit 200 for driving the piezoelectric elements 300 is mounted on the connection wire 220. As the driving circuit 200, for example, a circuit board, a semiconductor integrated circuit (IC) or the like may be used. The front end portion of the lead electrode 90 led from each of the piezoelectric elements 300 to the outside of the piezoelectric element holding portion 32 is electrically connected to the driving circuit 200 via a driving wire 210.

In addition, a compliance substrate 40 including a sealing film 41 and a fixed plate 42 is formed on the protective substrate 30. The sealing film 41 is formed of a flexible material with low rigidity, and one surface of the reservoir portion 31 is sealed by the sealing film 41. In addition, the fixed plate 42 is formed of a relatively rigid material. Since an area opposing the reservoir 100 of the fixed plate 42 becomes an opened portion 43 which is completely removed in the thickness direction, one surface of the reservoir 100 is sealed by only the sealing film 41 having flexibility.

In the ink jet recording head of the present embodiment, an ink is introduced from an ink introduction port connected to an external ink supplying unit (not shown), the ink is filled from the reservoir 100 to the nozzle openings 21, a voltage is applied between the lower electrode film 60 and the upper electrode film 80 corresponding to the pressure generation chambers 12 according to a recording signal from the driving circuit 200, and the elastic film 50, the insulating film 55, the lower electrode film 60 and the piezoelectric layer 70 are bent, such that the pressure of the pressure generation chambers 12 is increased so as to eject ink droplets from the nozzle openings 21.

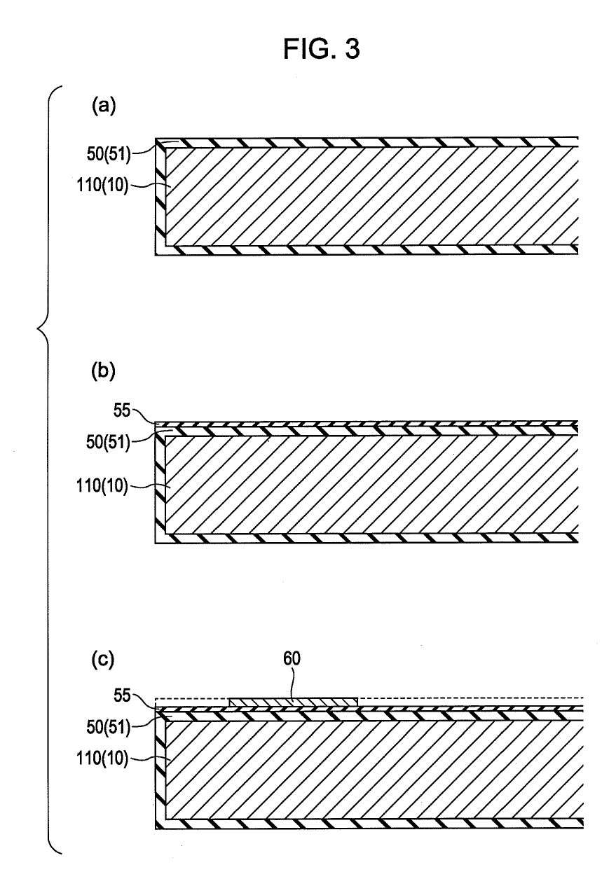

Hereinafter, a method for manufacturing such an ink jet recording head will be described with reference to FIGS. 3 to 7. FIGS. 3 to 7 are views showing the method for manufacturing the ink jet recording head which is a liquid ejecting head according to Embodiment 1 of the invention and are cross-sectional views of each of the pressure generation chambers in a width direction.

First, as shown in FIG. 3(a), the silicon dioxide film 51 formed of silicon dioxide (SiO₂) configuring the elastic film 50 is formed on the surface of a wafer 110 for the channel forming substrate, which is a silicon wafer including the plurality of channel forming substrates 10 integrally formed therein. Next, as shown in FIG. 3(b), the insulating film 55 formed of zirconium oxide is formed on the elastic film 50 (silicon dioxide film 51). Next, as shown in FIG. 3(c), the lower electrode film 60 is formed on the whole surface of the insulating film 55 and is patterned in a predetermined shape. The material of the lower electrode film 60 is not specially limited. However, if lead zirconium titanate (PZT) is used as the piezoelectric layer 70, a material of which a conductive variation hardly occurs due to the diffusion of lead oxide is preferably used. Accordingly, as the material of the lower electrode film 60, platinum, iridium or the like is suitably used.

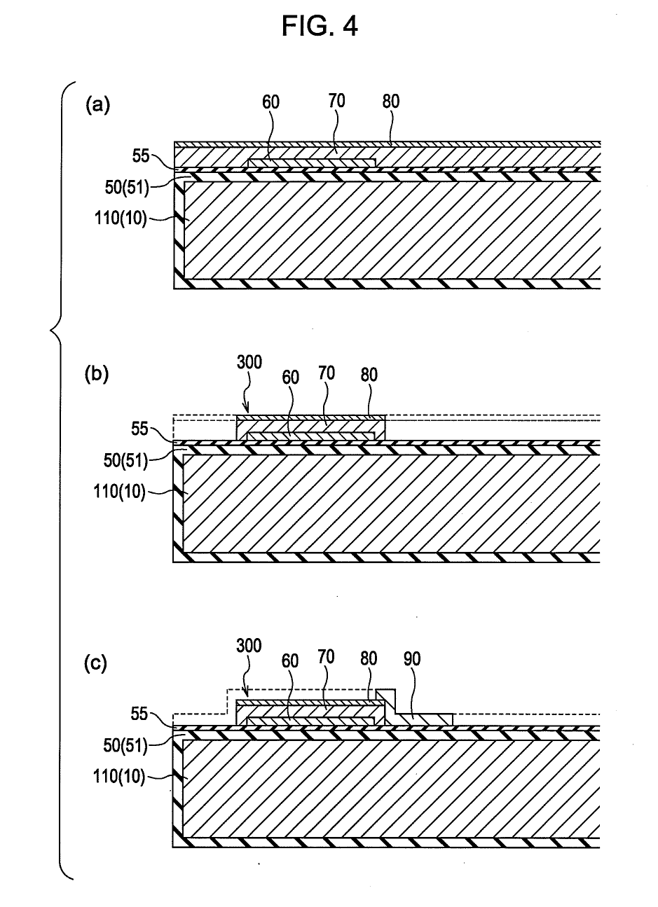

Next, as shown in FIG. 4(a), the piezoelectric layer 70 and the upper electrode film 80 are sequentially laminated on the lower electrode film 60. In the present embodiment, the piezoelectric layer 70 is formed using a so-called sol-gel method for coating, drying and gelling so-called sol obtained by dissolving and dispersing a metal organic matter in a solvent and performing firing at a high temperature so as to obtain the piezoelectric layer 70. The method for forming the piezoelectric layer 70 is not limited to the sol-gel method, and, for example, a metal-organic decomposition (MOD) method, a sputtering method, a physical vapor deposition (PVD) method such as a laser ablation method or the like may be used. In addition, as the material of the upper electrode 80, metal having high conductivity, for example, iridium (Ir) or the lime may be used.

Next, as shown in FIG. 4(b), the piezoelectric layer 70 and the upper electrode film 80 are simultaneously patterned so as to form the piezoelectric elements 300.

Next, the lead electrode 90 is formed. In detail, as shown in FIG. 4(c), the lead electrode 90 is formed over the whole surface of the wafer 110 for the channel forming substrate and is then patterned in each of the piezoelectric elements 300 via, for example, a mask pattern (not shown) formed of resist.

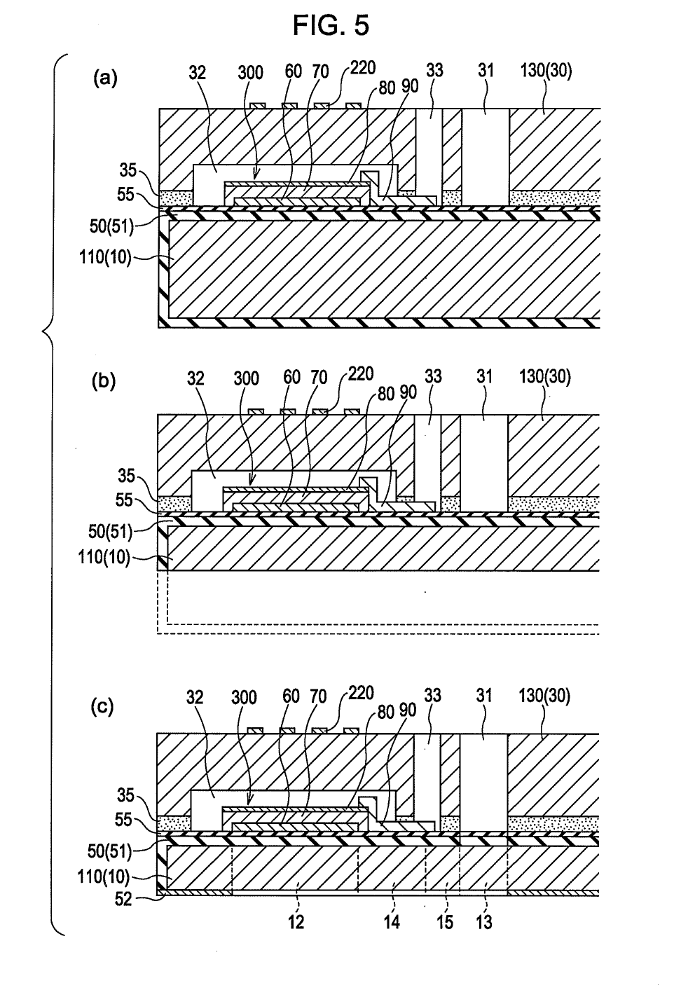

Next, as shown in FIG. 5(a), a wafer 130 for the protective substrate, which is a silicon wafer and is divided into the plurality of protective substrates 30, is bonded to the wafer 110 for the channel forming substrate at the side of the piezoelectric elements 300 via an adhesive 35. In the wafer 130 for the protective substrate, the reservoir portion 31, the piezoelectric element holding portion 32, the through-hole 33 and the connection wire 220 are formed in advance.

Next, as shown in FIG. 5(b), the wafer 110 for the channel forming substrate is thinned to a predetermined thickness. Next, as shown in FIG. 5(c), a mask film 52 is newly formed on the wafer 110 for the channel forming substrate and is patterned in a predetermined shape.

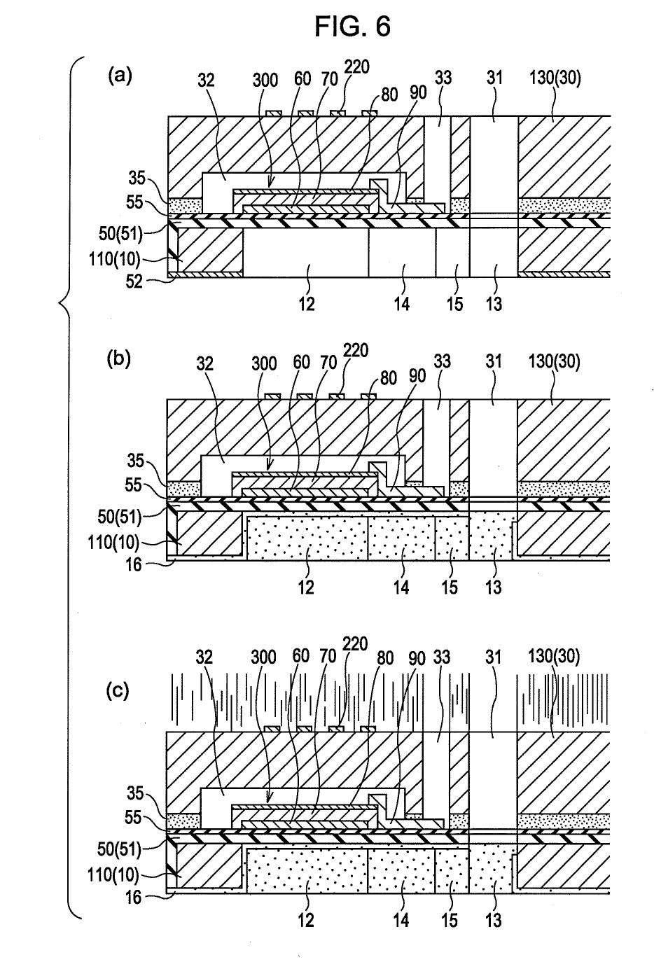

In addition, as shown in FIG. 6(a), the wafer 110 for the channel forming substrate is anisotropically etched (wet etched) using an alkali solution such as KOH or the like via the mask film 52 such that the pressure generation chambers 12, the communicating portion 13, the ink supply paths 14, the communicating paths 15 and so on corresponding to the piezoelectric elements 300 are formed. At this time, although not specially shown, actually, the surface of the wafer 130 for the protective substrate, on which the connection wire 220 is provided, is protected by a sealing film, in order to prevent the wafer 130 for the protective substrate from being simultaneously etched and to protect the connection wire 220. As such a sealing film, a material having alkali resistance (etching resistance), for example, polyphenylene sulfide (PPS), poly paraphenylene terephthalamide (PPTA) or the like may be used. By providing the sealing film, it is possible to prevent a failure such as the disconnection of the connection wire 220 provided on the surface of the wafer 130 for the protective substrate with certainty.

Next, the mask film 52 of the surface of the wafer 110 for the channel forming substrate is removed and, as shown in FIG. 6(b), a protective film 16 is formed on the inner surfaces of the liquid channels, that is, the inner surfaces of the pressure generation chambers 12, the communicating portion 13, the ink supply paths 14 and the communicating paths 15. In addition, the protective film 16 is formed of a material having liquid resistance (ink resistance) such as oxide, nitride or the like and is formed of tantalum pentaoxide in the present embodiment. The method for forming the protective film 16 is not specially limited, but may be formed by a CVD method.

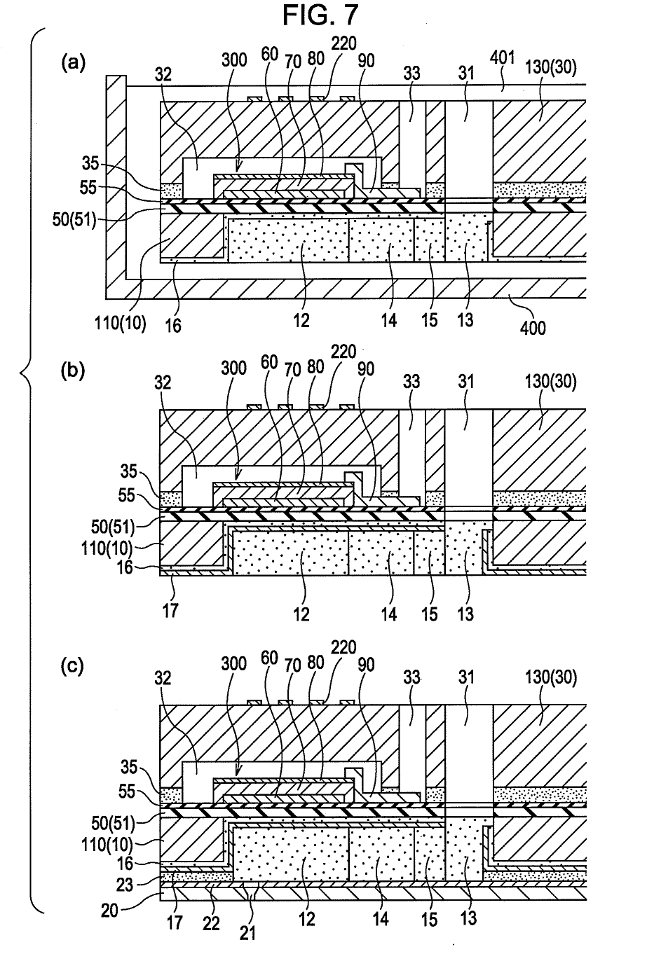

Next, an assembly of the wafer 110 for the channel forming substrate and the wafer 130 for the protective substrate is cleaned (a cleaning process). In the present embodiment, first, as shown in FIG. 6(c), the surface of the wafer 130 for the protective substrate on which the connection wire 220 is provided is subjected to a dry cleaning process of performing cleaning by dry etching of a plasma etching mode and, as shown in FIG. 7(a), a liquid cleaning process of cleaning the surface of the wafer 110 for the channel forming substrate at the liquid channel side including the pressure generation chambers 12 is then performed.

The dry etching of the plasma etching mode (PE mode) is generally a method for using reaction gas obtained by mixing chlorine gas and oxygen gas or reaction gas obtained by mixing organic gas thereto, and removes a foreign matter attached to the connection wire 220 of the surface of the wafer 130 for the protective substrate. The adhesive is attached to the connection wire 220 in plenty as the foreign matter when the sealing film is stripped, and the residue of the adhesive is mainly removed in the dry cleaning process. Accordingly, it is possible to prevent a connection failure from occurring when the driving circuit 200 or an external wire is connected to the connection wire 220.

In addition, a liquid cleaning process removes the foreign matter attached to the liquid channels by a cleaning solution and, in the present embodiment, for example, the foreign matter is removed by ethanol, ethanol is removed by washing, and moisture is removed by isopropyl alcohol (IPA). By this liquid cleaning process, it is possible to remove the foreign attached to the liquid channels and, more particularly, the adhesive which is scattered and reattached by the plasma etching mode, or the like, with certainty. In addition, in the liquid cleaning process of the present embodiment, as shown in FIG. 7(a), the assembly of the wafer 110 for the channel forming substrate and the wafer 130 for the protective substrate is immersed in a cleaning solution 401 filled in a cleaning bath 400. The cleaning method of the liquid cleaning process is not specially limited and, for example, a cleaning solution may be ejected to the surface of the wafer 110 for the channel forming substrate in which the liquid channels are provided.

In addition, in the present embodiment, the liquid cleaning process is performed after the dry cleaning process is performed. Accordingly, it is possible to remove the foreign matter, which is scattered by the dry cleaning process and is reattached to the liquid channels, with certainty by the liquid cleaning process.

In the assembly of the plurality of wafer states, in the present embodiment, the cleaning process of performing the liquid cleaning process after the dry cleaning process is performed and the cleaning process of performing the dry cleaning process after the liquid cleaning process is performed were performed and the generation ratios of the foreign matter in the liquid channels in the cleaning processes were measured. This result is shown in Table 1. In addition, the foreign matter in the liquid channel indicates the foreign matter equal to or larger than the inner diameter (for example, 15 μm, in the present embodiment) of the nozzle openings 21 and the generation ratio of the foreign matter in the liquid channels indicates the number of chips in which the foreign matter is present.

TABLE 1

Generation ratio of
foreign matter in
liquid channels

| | | |
|---|---|---|
| Dry cleaning process → | 18/3054 | 0.5% |
| Liquid cleaning process | | |
| Liquid cleaning process → | 36/3153 | 1.1% |
| Dry cleaning process | | |

As shown in Table 1, by performing the liquid cleaning process after the dry cleaning process of the present embodiment is performed, it is possible to reduce the generation of the foreign matter, compared with the case where the liquid cleaning is first performed. That is, it can be seen that the foreign matter scattered in the dry cleaning process is reattached to the liquid channels and the reattached foreign matter can be removed in the liquid cleaning process of the post-process.

In addition, although, in the present embodiment, the liquid cleaning process is performed after the dry cleaning process, the foreign matter attached to the connection wire 220 can be removed even when the dry cleaning process is performed after the liquid cleaning process is performed.

In addition, it may be considered that the surface of the wafer 110 for the channel forming substrate in which the liquid channels are provided is cleaned by the dry etching (dry cleaning process) of the plasma etching mode. However, since the surface is thinly removed in the plasma etching mode, the thickness of the protective film 16 provided on the surface of the liquid channels is reduced and thus this method cannot be performed. Even when the protective film 16 is not provided, since the thickness of the vibration plates or the volume of the liquid channels is changed by the dry cleaning process, this method cannot be performed. In the invention, by performing the liquid cleaning process with respect to the liquid channel side, it is possible to remove only the foreign matter in the liquid channels, without changing the thickness of the protective film 16 or the vibration plates, the volume of the liquid channels or the like.

Next, as shown in FIG. 7(b), the surface of the wafer 110 for channel forming substrate in which the liquid channels are opened is subjected to a hydrophilic treatment. The hydrophilic treatment is to improve the adhesion force of the adhesive 23 bonded with the nozzle plate 20 and, for example, a corona treatment, a plasma treatment, a treatment using UV irradiation or a hydrophilic treatment agent may be used. In the present embodiment, the wafer 110 for the channel forming substrate was subjected to the primer treatment so as to form the first hydrophilic treatment layer 17. In addition, the hydrophilic treatment is performed in at least an area of the channel forming substrate 10, to which the nozzle plate 20 is bonded, and, in the present embodiment, the first hydrophilic treatment layer 17 was formed on the inner surfaces of the liquid channels by immersing the wafer 110 for the channel forming substrate in a primer solution.

In addition, the above-described liquid cleaning process functions as a pre-process of performing the hydrophilic treatment. That is, before the hydrophilic process, a cleaning process of removing the foreign matter on the surface which is subjected to the hydrophilic treatment is required. However, in the present embodiment, since the foreign matter is removed by the previous cleaning process, the cleaning process does not need to be performed by the hydrophilic treatment. The liquid cleaning process using the cleaning solution may be performed again before the hydrophilic process is performed.

In addition, by performing the liquid cleaning process with respect to the wafer 110 for the channel forming substrate before the hydrophilic process, it is possible to prevent the foreign matter attached to the liquid channels from being covered by the first hydrophilic treatment layer 17 and prevent the nozzles from being clogged due to the stripping of the foreign matter at an unexpected timing such as the ejection of the ink with certainty.

Next, as shown in FIG. 7(c), the nozzle plate 20 is bonded via an adhesive 23. In addition, the nozzle openings 21 are formed in the nozzle plate 20 in advance, and the second hydrophilic treatment layer 22 is formed on the surface of the nozzle plate bonded to the wafer 110 for the channel forming substrate, by performing the hydrophilic treatment. Accordingly, it is possible to improve the adhesion strength between the wafer 110 for the channel forming substrate and the nozzle plate 20.

Thereafter, an unnecessary portion of the outer edge of the wafer 110 for the channel forming substrate and the wafer 130 for the protective substrate is removed by, for example, cutting such as dicing or the like. The compliance substrate 40 is bonded to the wafer 130 for the protective substrate, and the wafer 110 for the channel forming substrate or the like is divided into the channel forming substrates 10 each having one chip size shown in FIG. 1, thereby forming the ink jet recording head of the present embodiment.

### Other Embodiments

Although the embodiment of the invention is described, the basic configuration of the invention is not limited to the above-described embodiment. For example, although the silicon single crystal substrate having the plane orientation (110) is described as the channel forming substrate 10 in Embodiment 1, the invention is not limited to this. For example, a silicon single crystal substrate having a plane orientation (100) may be used or a material such as a SOI substrate or glass may be used.

Although the thin-film type piezoelectric elements 300 are described as the pressure generation units for causing variations in pressure in the pressure generation chambers 12 in Embodiment 1, the invention is not limited to this. For example, a thick-film type piezoelectric element formed by a method for adhering a green sheet, a vertical vibration type piezoelectric element for alternately laminating a piezoelectric material and an electrode forming material so as to expand or contract in an axial direction or the like may be used. In addition, units which include heating elements arranged in the pressure generation chambers and eject liquid droplets from the nozzle openings by bubbles generated by the heating of the heating elements or units for generating static electricity between the vibration plates and the electrodes, deforming the vibration plates by static electricity force, and ejecting liquid droplets from the nozzle openings, or the like may be used as the pressure generation units.

Although, in Embodiment 1, ethanol, washing and IPA are sequentially used as the cleaning solution in the liquid cleaning process, the invention is not limited to this and the cleaning solution is properly selected according to the type of the foreign matter (the type of the adhesive).

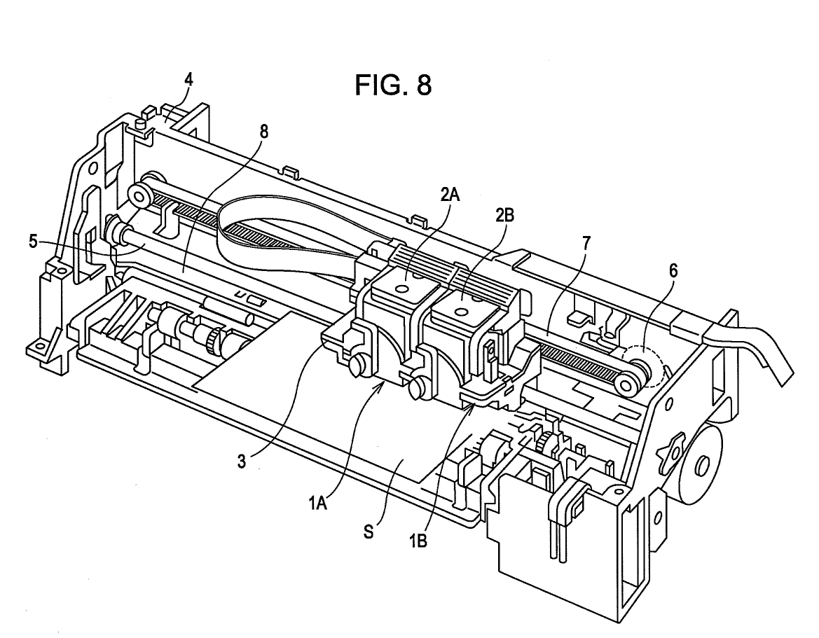

Such an ink jet recording head of Embodiment 1 configures a portion of a recording head unit including ink channels communicating with ink cartridges or the like so as to be mounted in an ink jet recording apparatus which is an example of the liquid ejecting apparatus. FIG. 8 is a schematic view showing an example of the ink jet recording apparatus. As shown in FIG. 8, cartridges 2A and 2B configuring an ink supply unit are detachably mounted in the recording head units 1A and 1B each having the ink jet recording head, and a carriage 3 in which the recording head units 1A and 1B are mounted is axially movably provided on a carriage shaft 5 mounted in an apparatus main body 4. The recording head units 1A and 1B eject, for example, a black ink composition and a color ink composition, respectively. A driving force of a driving motor 6 is delivered to the carriage 3 via a plurality of gears (not shown) and a timing belt 7, and the carriage 3 in which the recording head units 1A and 1B are mounted is moved along the carriage shaft 5. In the apparatus main body 4, a platen 8 is provided along the carriage shaft 5, and a recording sheet S which is a recording medium such as paper feed by a feed roller (not shown) or the like is transported on the platen 8.

In addition, although the ink jet recording apparatus is described as an example of a serial type liquid ejecting apparatus in FIG. 8, the invention is applicable to an ink jet recording apparatus (line printer) which is an example of a line head type liquid ejecting apparatus.

Although the ink jet recording head is described as an example of the liquid ejecting head in Embodiment 1, the invention relates to general liquid ejecting heads and is applicable to a method for manufacturing a liquid ejecting head for ejecting a liquid excluding an ink. The other liquid ejecting heads may, for example, include: various kinds of recording heads used in an image recording apparatus such as a printer; coloring material ejecting head used for manufacturing color filters of a liquid crystal display and the like; an electrode material ejecting head used for forming electrodes of an organic EL display, a FED (field emission display) and the like; a bio-organic matter ejecting head used for manufacturing biochips; and the like. The liquid ejecting apparatus including the liquid ejecting head mounted therein is not limited to the ink jet recording apparatus and is applicable to a liquid ejecting apparatus for ejecting a liquid excluding an ink.

1. A method for manufacturing a liquid ejecting head including at least a first substrate in which pressure generation chambers communicating with nozzle openings are provided, pressure generation units provided at one surface side of the first substrate so as to cause a pressure variation in the pressure generation chambers, and a second substrate bonded to the surface of the first substrate, in which the pressure generation units are provided, and having a wire formed on the surface thereof, the method comprising:
performing a dry cleaning process of cleaning the surface of the wire side of the second substrate by dry etching of a plasma etching mode; and
performing a liquid cleaning process of cleaning the surface of the pressure generation chamber side of the first substrate.

2. The method according to claim 1, wherein the dry cleaning process is performed after the liquid cleaning process is performed.

3. The method according to claim 1, further comprising adhering a nozzle plate, in which the nozzle openings are provided, to an opened surface side of the first substrate, in which the pressure generation chambers are opened, after the cleaning process is performed.

4. The method according to claim 1, wherein, after the cleaning process is performed, at least an area of the first substrate, which is bonded to the nozzle plate, is subjected to a hydrophilic treatment, and the nozzle plate is then is bonded to the second forming substrate via an adhesive.

5. The method according to claim 1, further comprising forming a protective film having liquid resistance on the inner surfaces of the pressure generation chambers of the first substrate, before the cleaning process is performed.

6. A liquid ejecting apparatus comprising the liquid ejecting head manufactured by the method for manufacturing the liquid ejecting head according to claim 1.
